(19) United States
(12) Patent Application Publication
(10) Pub. No.: US 2002/0007745 A1
(43) Pub. Date: Jan. 24, 2002

(54) Device for assembly of tubular carrier elements

(76) Inventors: Christian Compera, Schonau (DE); Wolfgang Alberstadt, Stockstadt am Rhein (DE)

Correspondence Address: Lawrence P. Kessler, Patent Department, NexPress Solutions LLC, 1447 St. Paul Street, Rochester, NY, 14653-7103, US

(21) Appl. No.: 09/850,045

(22) Filed: May 7, 2001

(30) Foreign Application Priority Data
May 12, 2000 (DE) 100 23 152.7

(51) Int. Cl. B41F 1/00; B41F 5/00

(52) U.S. Cl. 101/216

(57) ABSTRACT

The invention concerns a device for assembly of tubular cylindrical carriers (8) on the circumference (22) of carrier cylinders (1) of drums or cylinders, wherein for the assembly of the tubular carrier (8) on the lateral surface (22) a pressure medium acts upon the latter. By attaching an assembly aid (4), on which a tubular carrier (8) can be held, on the carrier cylinder (1), a pressure medium acts upon the latter, so that positioning of the tubular carrier (8) is made possible.

The present invention concerns a device for assembly of tubular carrier elements, for example tubular channel-less carriers, on the circumference of which a functional layer can be made in the form of a photoelectric layer.

U.S. Pat. No. 5,215,013 refers to a device for noise damping in the case of covering the peripheral area of a press cylinder with a tubular rubber blanket. This device preferably is used on the press of an offset press, which is equipped with channel-less press cylinders. The rubber blanket is expandable in the circumferential direction, for which a pneumatically generated pressure can act on the inside of the rubber blanket sleeve. Then the expanded rubber blanket sleeve is pushed laterally over the surface of the cylinder. The rubber blanket sleeve is provided with a damping ring for damping the noise, which is caused by the lateral emergence of the compressed air. The high-frequency noise, generated by oscillations of the rubber blanket sleeve which is under pressure, is damped by means of the damping ring. The cylinder surface is provided with exit holes, which create and maintain the air cushion at the time of pushing the rubber blanket sleeve over the surface of the cylinder, at the place at which the rubber blanket sleeve is set laterally on the cylinder surface for pushing.

U.S. Pat. No. 5,649,267 refers to a cylinder arrangement which can be used in a press unit. An essentially tubular element, on the surface of which a toner image can be generated, is used on the cylinder arrangement which is made essentially drum-shaped. The drum surface includes open ends, the flat sides of which are supported by disk-like peripheral areas supporting the lateral surface. The flat sides, with which the openings of the cylindrically configured surface can be closed, are cooled before assembly, in order then to be let into the openings of the surface. The flat sides, which are shrunken into the cylinder surface ends in this way, in this case are provided with shaft bearings. A shaft passing through the drum arrangement in the axial direction is received in the shaft bearings. The eccentricity of the drum casing can be preset relative to the rotation axis by the adjustment screws provided on the flat sides.

In the case of electrographic press units, wear of the functional layer takes place on cylinders, the surface of which can be provided with a functional layer, for example a photoelectric layer. This wear of the functional layer makes replacement of the functional layer necessary. In order to be able to perform the replacement, the sleeve which holds the functional layer in each case is changed inside or outside the press unit. In this case a positionally correct pushing of the cylinder sleeve carrying the functional layer is mandatory.

In view of the solutions known from the prior art and the technical problem indicated, the object of the invention is to make reliable assembly of a cylinder covering on a carrier cylinder possible.

According to the invention this object is achieved by the features of Patent claim 1.

The advantages resulting from the solution proposed according to the invention are to be seen above all in the fact that the covering to be applied can be positioned laterally almost seamlessly on the surface of the carrier cylinder by setting the assembly aid on a flat side of the carrier cylinder. The air cushion generated by a pressure medium, supporting the process of mounting the tubular carrier, is created only when the assembly aid is positioned on the stop surface of the carrier cylinder correspondingly provided therefor. The surface of the tubular carrier to be mounted is protected effectively on the assembly aid, since a cover overlapping the surface of the covering tubular carrier is provided.

In a further configuration of the concept on which the invention is based, in each case switch elements for switching the pressure medium on and off can be provided on the carrier cylinder or in the assembly aid. This assures that the pressure medium is applied only when it is also actually necessary, namely during the process of positioning the tubular carrier to be applied laterally onto the surface of the carrier cylinder.

The circumstance that the action of exit openings for the pressure medium in each case exerted on the peripheral surface of the assembly aid and on the circumference of the carrier cylinder takes place only when assembly aid and carrier cylinder lie against one another on a stop surface is particularly advantageous. The correct arrangement of the assembly aid on the carrier cylinder can be achieved by having one of the bearing pins of the carrier cylinder serve as a centering element. The bearing pin serving as a centering element works together with a receptacle provided inside the assembly aid, which in a preferred configuration can be made as a hole extending along the rotation axis of the assembly aid and the carrier cylinder. The receptacle can be made both parallel to the rotation axis of the assembly aid and the centering element; the receptacle can be made just as well coaxial to the rotation axis of the carrier cylinder and assembly aid. In order to assure the centering of the assembly aid on the bearing surface of the carrier cylinder, the receptacle can be provided with an opening on a flat side, in which an end of the bearing pin functioning as a centering element can be received. The accuracy and duration of the centering is increased significantly by having the receptacle overlap the end of the bearing pin with a covering area, so that the centering of the assembly aid can be maintained while it lies tight against the bearing surface. The assembly aid includes an outlet opening into its lateral surface for a pressure medium, wherein the latter opens in particular in an area under cover protecting the tubular carrier. A ring slot extending over the axial length is made between the lateral surface of the assembly aid and the cover for protecting the surface or the tubular carrier.

In order to assure that the pressure medium acting on the carrier cylinder and assembly aid can be switched on and off in the case of axial positioning of the tubular carrier, an operating element is made on the assembly aid. The operating element, for example made as a pin, penetrates a flat side of the carrier cylinder in the case of contact of the assembly aid with a bearing surface on the carrier cylinder, and causes a pressure medium to flow out into the corresponding outlet openings on the lateral surface of carrier cylinder and assembly aid.

The operating element made, for example, as a pin can be operable also in the axial direction; operation of the same in the radial direction is equally well conceivable. In the case of pin-shaped configuration of the operating element provided on the assembly aid the latter penetrates the flat side in the case of installation of the assembly aid on a bearing pin of the carrier cylinder and corresponding centering by holding on a bearing pin of the carrier cylinder in such a way that the end of the operating element is in contact with a conical switch element, which operates a valve provided with the carrier cylinder. The pressure provided via a pressure medium line is directed into the carrier cylinder opening via a connection through the bearing pin turned away from the bearing surface onto the surface of the carrier cylinder and assembly aid. In addition, outlet openings are made in the mounting area of assembly area and carrier cylinder, which both open into the hole which is penetrated by the operating element and into which the pressure medium flowing out from the pressure line released by the valve arrangement in the carrier cylinder opens and which acts upon the peripheral surfaces of the two components mentioned.

The device proposed according to the invention advantageously can be used in a press with which both a web-like printing material as well as a printing material in sheet form can be printed on one or both sides. The press can be part of a printing press, which contains one or more presses, a toner image being generated on the lateral surface of the channel-less tubular carrier form to be mounted.

The invention is explained in greater detail below by means of the drawing.

Here

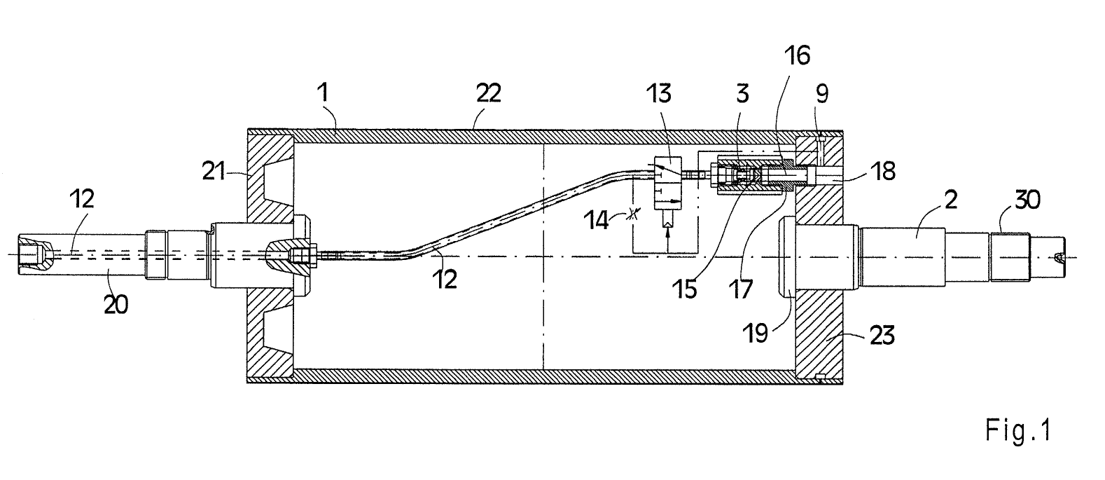

FIG. 1 shows a longitudinal section through a carrier cylinder arrangement with a switch valve held in the interior for the pressure medium supplied on the bearing pin side,

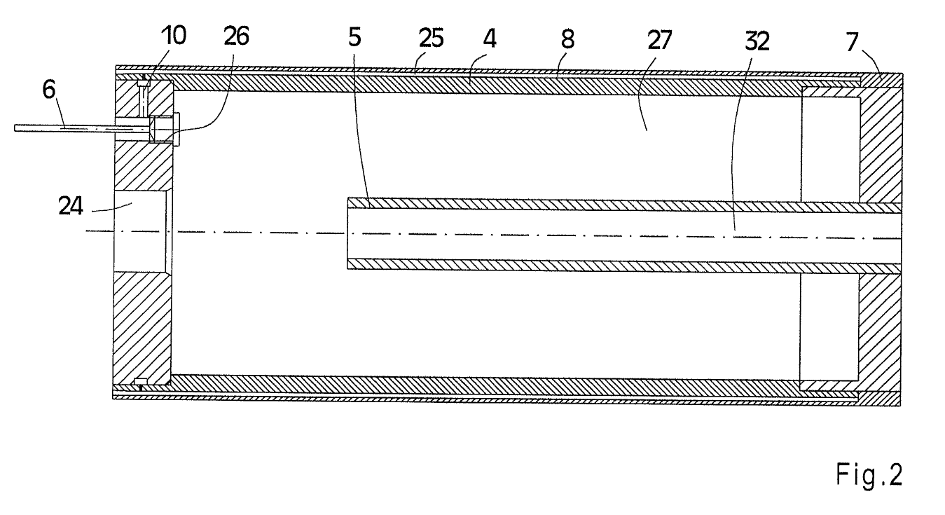

FIG. 2 shows the longitudinal section through a mounting aid with a receptacle made coaxial to the axis of rotation of the assembly aid and in which with a pin-shaped operating element held on the flat side, for example screwed in here, for the switch arrangement of a carrier cylinder and

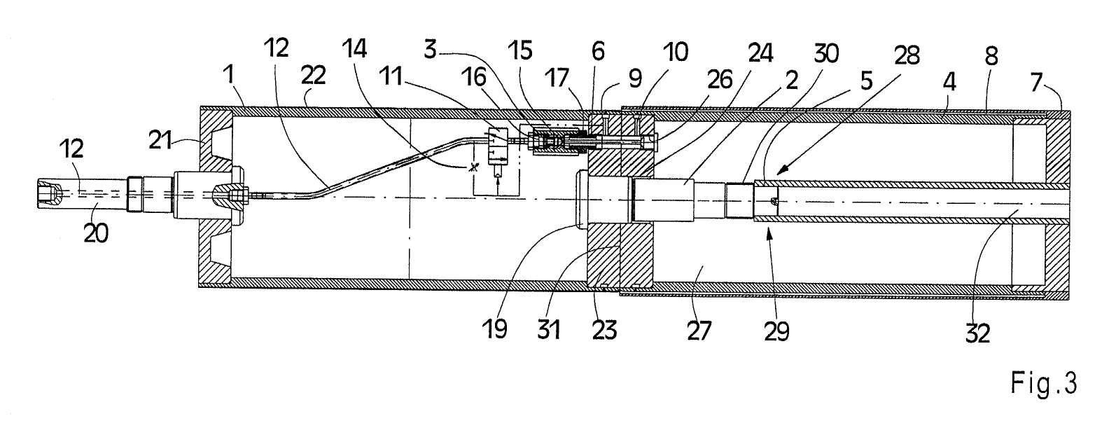

FIG. 3 shows the assembly aid centered on a bearing pin of the carrier cylinder, carrier cylinder and assembly aide lying against one another on a bearing surface and the operating element acting on a pendant on the switch valve for releasing the pressure medium.

It follows from the presentation according to FIG. 1 that there is a carrier cylinder with bearing pins in each case held on the flat sides, through the interior of which a supply line of a pressure medium extends up to a valve arrangement.

The essentially carrier cylinder 1 made essentially rotation-symmetrical to its rotation axis contains two bearing pins 2 to 20, of which bearing pin 2 serves as a centering pin. In its interior, which is bounded by a lateral surface 21, respectively 23, there is a switch element 3, which can be made, for example, as a pneumatic switch element. Between switch element 3 and a supply line of a pressure medium 12 there is a valve arrangement 13, which functions essentially as a two-way valve arrangement. A throttle element 14, via which the pressure in an outlet opening, which opens into the lateral surface 22 of the carrier cylinder 1, can be removed and which opens into the supply line 12 for a pressure medium, is associated with valve arrangement 13.

A conical operating element 15, which is made aligning with a spacer 17, in which a hole 16 is made, is made on the pneumatically operating switch element 3. The hole 16 in the spacer 17 essentially aligns with the hole 18 made in the flat side 23 and is screwed with the latter via a thread. The bearing pin of the carrier cylinder functioning as a centering pin 2 is held on the flat side 23 and fits against the inside of the flat side via a collar 19 made on the carrier cylinder. A mounting surface serving as a centering surface is made beside a thread on the centering pin 2.

On the opposite bearing pin 20 of the carrier cylinder 1 proposed according to the invention, a supply line 12 of a pressure medium passing essentially coaxially, penetrating the carrier cylinder 1, which pressure medium can be made within the carrier cylinder in lines passed through as a compressed air line and opens on the valve arrangement 13.

The lateral surface 22 of the carrier cylinder 1 is made according to FIG. 1 as a channel-less uninterrupted peripheral area, onto the circumference of which a tubular cattier 8 (not shown here) can be pushed and positioned. For example, the tubular carrier 8 can be a cylinder sleeve, on the surface of which an electrographic layer can be formed, on which a toner image can be created according to the electrography principle.

Instead of an uninterrupted carrier piece penetrating the carrier cylinder 1 penetrating from flat side 23 to flat side 21, with bearing pins made thereon, in the presentation according to FIG. 1 the bearing, respectively centering pins 2, respectively 20 are mounted as pins, in each case in their flat sides 21, respectively 23. This produces an open space within the cavity of the carrier cylinder 1, in which the switch element 3, respectively the valve arrangement 13, as well as an overload throttle 14 and the line 12 extending from the bearing pin 20 can be held.

According to the representation shown in FIG. 2, there is a longitudinal section through the assembly aid proposed according to the invention, through which a receptacle 5 passes coaxial to the rotation axis.

From the representation shown in FIG. 2 it follows that the assembly aid 4 essentially is made of a lateral surface and two flat sides. In the flat side which is located opposite the operating element 6, a receptacle 5 is mounted coaxial to the rotation axis of the assembly aid 4. The receptacle 5 extends essentially over more than half of the axial extent of the assembly aid 4. The receptacle 5 is penetrated by a hole extending axially. The operating element 6 is screwed on the flat side opposite the end of the receptacle 5 as an operating element 6 made as a pin. An outlet hole 10, which opens into the lateral surface of the assembly aid 4, branches from the hole into which the operating element 6 is screwed on a thread 26. In addition to the pin-shaped configuration of the operating element 6 shown, it can also be made in different shapes. In the flat side receiving the operating element 6—here shown as a pin—there is also an opening 24, which (see FIG. 3) can be penetrated by a bearing pin 2 of the carrier cylinder 1 functioning as a centering pin. The end of the receptacle 5 is located opposite the receiving hole 24 in this flat side of the assembly aid 4.

A tubular carrier 8 can be held on the circumference of the assembly aid 4, in a ring slot 25, bounded by the lateral surface of the assembly aid 4 and a protective covering 7 extending coaxial thereto. The surface of this carrier, for example made as a photoelectrically sensitive coating, is effectively protected with this against external influences such as scratching, contact, or wetting with liquids or fluids, and therefore is very extensively shielded against external influences in the case of handling.

An assembly aid 4, which is centered on a flat side 23, which functions as a bearing surface, follows from the representation according to FIG. 3.

From the representation shown in FIG. 3 it follows that the assembly aid 4 (see FIG. 2) lies against the flat side 23 of the carrier cylinder 1. The bearing pin 2 lying in the flat side 23 with its collar 19 on the inside of the flat side 23 functions as a centering pin n this representation. The bearing pin 2 is pushed with its narrowed projection into the end opening of the receptacle 5, which penetrates the assembly aid 4 coaxially to the rotation axis thereof. The receptacle 5 is mounted in its end area in a flat side bordering the assembly aid 4.

The centering of the assembly aid takes place essentially through the adjusting covering 28 in the area of the receiving hole 29 of the receptacle 5 by introducing the narrowed area of the bearing pin 2 into the receptacle 5.

In this way it is assured that the operating element 6 made as a pin-shaped element penetrates the hole in the flat side of the assembly aid 4 containing the receiving hole 24 and engages aligning in the hole 18 penetrating the flat side 23 of the carrier cylinder. This hole 18 opens (see representation according to FIG. 1) into the hole 16 of a spacer 17, which lies opposite the conical operating element 15 of the pneumatic switch element 3. If the pin-shaped operating element 6 comes in contact with this conical surface, the valve arrangement 13 in the interior of the carrier cylinder 1 is operated and releases the feed of a pressure medium into the outlet openings 9 and 10. There is a sensor in the outlet opening 9, which is provided on the flat side 23 of the carrier cylinder 1. The sensor responds to the presence of a tubular carrier 8 to be pushed over the lateral surface 22 by an attached assembly aid 4 and switches the valve arrangement via the throttle element 14 in such a way that that the latter is brought to a volume flow which is brought for generating a force sufficient for pushing the tubular carrier 8 onto the lateral surface 22. As soon as the air cushion is formed, and the tubular carrier 8 has moved onto the lateral surface 22 of the carrier cylinder 4 and the assembly aide 4 is received by the flat side 23, the operating element 6 made as a pin moves back and shuts off the compressed air flow again.

In this way the tubular carrier 8 still enclosed by the covering 7 is easily expanded by the formation of an air cushion and can be pushed laterally onto the lateral surface 22 of the carrier cylinder 1. By the seamless transition between the lateral surface of the assembly aid 4, covered by the covering 7, with the lateral surface 22 of the carrier cylinder 1, a slight expansion of the tubular carrier is sufficient to pull the latter laterally onto the lateral surface 22 of the carrier cylinder 1. The air cushion forming on the assembly aid 4, generated by the outlet opening 10, advances seamlessly on the lateral surface 22 of the carrier cylinder 1, an outlet opening 9 also being provided in the flat side, which opening is acted upon by the pressure medium flowing into the hole 18 in the flat side 23 and which supports the formation of an air cushion on the lateral surface 22 of the carrier cylinder 1 under the tubular carrier element 8 to be mounted laterally.

By attaching the assembly aid 4 first there is a contact of the operating element 6 made as a pin with the conical operating element 15 of the valve arrangement 13 in the interior of the carrier cylinder 1, so that the pressure medium can appear only when it is needed for covering the lateral surface 222 of the carrier cylinder 1 with the tubular carrier. During the lateral positioning of the tubular carrier 8 on the lateral surface 22 of the carrier cylinder 1 the centering of the peripheral surfaces of the assembly aid 4 and carrier cylinder 1 is ensured by enclosing the bearing pin of the carrier cylinder 1 serving as a centering pin 2 effectively by the receptacle 5 in the carrier cylinder and maintaining the centering. In this way an alignment of the flat side of the assembly aid 4 in the flat side 23 or of the flat side of the assembly aid receiving the operating element 5 during the lateral positioning of the tubular carrier 8.

The compressed air volume flow adjusting on the valve arrangement 13 can be controlled by equipping the outlet opening 9 in the flat side 23 with a sensor element. As soon as the tubular carrier 8 passes from the casing of the assembly aid 4 to the casing 22 of the carrier piece 1, the sensor provided in the outlet opening 9 detects this and increases via the adjustable throttle element 14 the volume flow from a first volume flow to a second stronger volume flow. In this way an air cushion, which permits a lateral displacement of the tubular carrier 8 from the assembly aid 4 onto the lateral surface 22, is formed under the tubular carrier 8 to be installed. If the tubular carrier 8 has reached its position and the assembly aid 4 bearing pin serving as a centering pin 2 is removed, the pinshaped operating element 6 emerges from the hole 18 and releases the operating element 15. In this way the compressed air volume flow is switched off in the valve arrangement 13.

1. A device for assembly of tubular, cylindrical carriers (8) on the lateral side (22) of a carrier cylinder (1), a pressure medium acting on the lateral surface (22) for assembly of the tubular carrier (8) on the lateral surface, wherein by attaching an assembly aid (4), which is capable of holding a tubular carrier (8), on the carrier cylinder (1) a pressure medium acts upon the latter so that positioning of the tubular carrier (8) is made possible.

2. The device according to claim 1, wherein switch elements (6, 11, 13, 15) for switching a pressure medium on and off are provided in the carrier cylinder (1) or in the assembly aid (4).

3. The device according to claim 1, wherein outlet openings (9, 10) for the emergence of the pressure medium are acted upon in the case of surface contact of carrier cylinder (1) and assembly aid (4).

4. The device according to claim 3, wherein a sensor element is held in one of the outlet openings (9, 10), which acts on switch elements of a carrier cylinder in the case of an attached assembly aid (4) in such a way that the volume flow of the pressure medium increases from a first volume flow strength to a second volume flow strength.

5. The device according to claim 1, wherein the assembly aid (4) may be centered on a bearing pin (2, 20) of the carrier cylinder (1).

6. The device according to claim 5, wherein the assembly aid (4) is provided with a receptacle (5) for a bearing pin (2, 20) serving as a centering element.

7. The device according to claim 6, wherein the receptacle (5) extends parallel to the rotation axis of the assembly aid (4) and the bearing pin (2, 20) serving as a centering element.

8. The device according to claim 6, wherein the receptacle (5) passes coaxial to the rotation axis of the carrier cylinder (1) and assembly aid (4).

9. The device according to claim 5, wherein the receptacle (5) aligns with an opening (24) in a flat side of the assembly aid (4).

10. The device according to claim 5, wherein the receptacle (5) overlaps one end of a bearing pin (2, 20) with covering (28), serving as a centering element.

11. The device according to claim 5, wherein the assembly aid (4) contains at least one outlet opening (100 for a pressure medium, opening into its lateral surface.

12. The device according to claim 5, wherein the assembly aid (4) contains a covering (7) overlapping a ring slot (26) to the lateral surface.

13. The device according to claims 5 and 11, wherein the outlet opening (10) opens into the ring slot (25) under the covering (7).

14. The device according to claim 1, wherein the assembly aid (4) contains an operating element (6), which in the case of contact with the carrier cylinder (1), penetrating the flat side (23) thereof, cause a pressure medium to emerge.

15. The device according to claim 1, wherein the carrier cylinder (1) contains an outlet opening (9), made in a flat side (23), opening into its lateral surface (22).

16. The device according to claim 14, wherein the operating element (6) is operable in the axial direction.

17. The device according to claim 14, wherein the operating element (6) is operable in the radial direction.

18. The device according to claim 1, wherein the operating element (6) operates an operating element (15) of a valve arrangement (13) in the case of attachment of the assembly aide (4) on the flat side (23) of the carrier cylinder (1) functioning as a bearing surface (31).

19. A press with a device for assembling tubular, cylindrical carriers (8) on the lateral surface (22) of a carrier cylinder (1), for assembly of the tubular carrier (8) in the lateral surface (22) a pressure medium acts upon the latter, wherein by attaching an assembly aid (4) on which a tubular carrier (8) can be held, on the carrier cylinder (1), a pressure medium acts upon the latter, so that positioning of the tubular carrier (8) is made possible.

20. A printing press with a device for assembling a tubular cylindrical carrier (8) on the lateral surface (22) of a carrier cylinder (1), for assembly of the tubular carrier (8) on the lateral surface (22) a pressure medium acts upon the latter, wherein by attaching an assembly aid (1) on the carrier cylinder (1) a pressure medium acts on the latter, so that positioning of the tubular carrier (8) is made possible.

21. An electrographic printing press with a device for assembly of tubular cylindrical carriers (8) on the lateral surface (22) of a carrier cylinder (1), for assembly of the tubular carrier (8) on the lateral surface, a pressure medium acts on the latter, wherein by attaching an assembly aid (4), on which a tubular carrier (8) may be held, on the carrier cylinder (1) a pressure medium acts on the latter sot that positioning of the tubular carrier (8) is made possible.
